(19) United States
(12) Patent Application Publication
(10) Pub. No.: US 2012/0287246 A1
(43) Pub. Date: Nov. 15, 2012

(54) IMAGE PROCESSING APPARATUS CAPABLE OF DISPLAYING IMAGE INDICATIVE OF FACE AREA, METHOD OF CONTROLLING THE IMAGE PROCESSING APPARATUS, AND STORAGE MEDIUM

(75) Inventor: Tatsushi Katayama, Kawasaki-shi (JP)

(73) Assignee: CANON KABUSHIKI KAISHA, Tokyo (JP)

(21) Appl. No.: 13/465,060

(22) Filed: May 7, 2012

(30) Foreign Application Priority Data
May 11, 2011 (JP) 2011-106212

(51) Int. Cl. H04N 13/02

(52) U.S. Cl. 348/46; 348/E13.074

(57) ABSTRACT

An image processing apparatus capable of appropriately displaying a face frame in a manner superimposed on a three-dimensional video image. In a three-dimensional photography image pickup apparatus as the image processing apparatus, two video images are acquired by shooting an object, and a face area is detected in each of the two video images. The face area detected in one of the two video images and the face area detected in the other video image are associated with each other. The three-dimensional photography image pickup apparatus generates face area-related information including positions on a display panel where face area images are to be displayed. The face area images are generated according to the face area-related information. The two video images are combined with the respective face area images, and the combined video images are output to the display panel.

### BACKGROUND OF THE INVENTION

1. Field of the Invention

The present invention relates to an image processing apparatus, a method of controlling the same, and a storage medium, and more particularly to an image processing apparatus capable of displaying a three-dimensional video image, a method of controlling the same, and a storage medium.

2. Description of the Related Art

Recently, an increasing number of movies and the like are provided as three-dimensional (3D) video images, and in accordance with this trend, home TV sets capable of three-dimensional display have been being developed. Further, a camera provided with two image pickup optical systems has been known as an apparatus for picking up 3D video images, and a consumer three-dimensional photography camera has also made its debut.

Each of recent digital cameras and video cameras is equipped with a function for detecting a human object before shooting and superimposing a face frame on a face area displayed on a liquid crystal panel of the camera. The camera controls shooting parameters of exposure, focusing, etc. using an image within the face frame, whereby the camera is capable of obtaining an image optimized for the human object.

As for the above-mentioned three-dimensional photography camera as well, by providing a camera body with a display section on which a three-dimensional image can be viewed, it is possible to perform shooting while checking a three-dimensional effect. In this case, an object being picked up is three-dimensionally displayed, and therefore the face frame as well is required to be superimposed on a human face area while being three-dimensionally displayed.

Conventionally, there has been proposed a device which displays three-dimensional image data, by superimposing thereon a mouse pointer for pointing to a predetermined position on a three-dimensional image or character information to be displayed together with a three-dimensional image (see e.g. Japanese Patent Laid-Open Publication No. 2001-326947).

This three-dimensional image display device is connected to a general personal computer and is used to edit a three-dimensional image using a mouse or to input characters onto a three-dimensional image using a keyboard. In this device, when a pointing unit, such as a mouse pointer, exists on a three-dimensional image, control is performed such that the pointing unit is displayed with a parallax in accordance with a parallax at a position on the three-dimensional image where the pointing unit is placed, so as to improve visibility of the pointing unit on the three-dimensional image.

In such related background art, when face detection is performed on left and right video images picked up by a three-dimensional photography camera, the size of a face frame and the relative position of the face frame with respect to a face area vary between the left video image and the right video image.

This will be described in detail with reference to FIG. 22. In FIG. 22, face detection is performed on left and right video images 1901 and 1902 picked up by the three-dimensional photography camera, and face frames 1903 to 1908 are displayed in a manner superimposed on respective face areas according to the result of the face detection. Since the face detection is performed on the left and right video images 1901 and 1902 on an individual basis, the size of each face frame and the relative position of the face frame with respect to an associated face area vary between the left video image 1901 and the right video image 1902.

As a result, the face frame looks doubly blurred when three-dimensionally viewed, or difference in three-dimensional effect is caused between the face and the face frame, or the left and right face frames follow differently from each other in accordance with movement of an associated human object, which degrades visibility of the three-dimensional image.

The technique disclosed in Japanese Patent Laid-Open Publication No. 2001-326947 is for adjusting the parallax of the pointing unit, such as a mouse pointer, according to the position of the pointing unit. Therefore, the size or the like of the mouse pointer is set to a predetermined value, so that it does not vary between the left and right images. As for the movement of the pointer on each of the left and right images, a mouse operation is detected, and a display position and a parallax are adjusted based on the result of the detection.

Therefore, it is impossible to three-dimensionally display a marker, such as a face frame, in an appropriate position based on information detected from video images input through the respective left and right image pickup systems.

### SUMMARY OF THE INVENTION

The present invention provides an image processing apparatus capable of appropriately displaying a face frame in a manner superimposed on a three-dimensional video image, a method of controlling the image processing apparatus, and a storage medium.

In a first aspect of the present invention, there is provided an image processing apparatus including a display unit, comprising an acquisition unit configured to acquire two video images obtained by shooting an object, a detection unit configured to detect a face area in each of the two video images acquired by the acquisition unit, a face area-setting unit configured to associate the face area detected in one of the two video images by the detection unit and the face area detected in the other video image by the detection unit, and set positions and sizes of the face areas associated with each other, for display on the display unit, such that the positions and sizes of the face areas match each other, a face area-related information generation unit configured to generate face area-related information including positions on the display unit where face area images indicative of the face areas set by the face area-setting unit are to be displayed, a face area image generation unit configured to generate the face area images according to the face area-related information generated by the face area-related information generation unit, and an output unit configured to combine the two video images with the face area images generated by the face area image generation unit, respectively, and output combined video images to the display unit.

In a second aspect of the present invention, there is provided a method of controlling an image processing apparatus including a display unit, comprising acquiring two video images obtained by shooting an object, detecting a face area in each of the acquired two video images, associating the face area detected in one of the two video images and the face area detected in the other video image, and setting positions and sizes of the face areas associated with each other, for display on the display unit, such that the positions and sizes of the face areas match each other, generating face area-related information including positions on the display unit where face area images indicative of the set face areas are to be displayed, generating the face area images according to the generated face area-related information, and combining the two video images with the generated face area images, respectively, and outputting combined video images to the display unit.

In a third aspect of the present invention, there is provided a non-transitory computer-readable storage medium storing a computer-executable program for executing a method of controlling an image processing apparatus including a display unit, wherein the method comprises acquiring two video images obtained by shooting an object, detecting a face area in each of the acquired two video images, associating the face area detected in one of the two video images and the face area detected in the other video image, and setting positions and sizes of the face areas associated with each other, for display on the display unit, such that the positions and sizes of the face areas match each other, generating face area-related information including positions on the display unit where face area images indicative of the set face areas are to be displayed, generating the face area images according to the generated face area-related information, and combining the two video images with the generated face area images, respectively, and outputting combined video images to the display unit.

According to the present invention, it is possible to provide an image processing apparatus capable of appropriately displaying a face frame in a manner superimposed on a three-dimensional video image.

Further features of the present invention will become apparent from the following description of exemplary embodiments with reference to the attached drawings.

### BRIEF DESCRIPTION OF THE DRAWINGS

FIG. 1 is a schematic block diagram of a three-dimensional image pickup apparatus as an image processing apparatus according to a first embodiment of the present invention.

FIG. 2 is a schematic block diagram of a right-eye-viewing face detection section appearing in FIG. 1.

FIG. 3 is a view showing an example of video images displayed on a display panel of the three-dimensional image pickup apparatus in FIG. 1.

FIG. 4 is a view useful in explaining a difference between object images.

FIG. 5 is a view of a left video image obtained on a projection plane and a right video image obtained on a projection plane.

FIG. 6 is a diagram showing timing for switching between left and right video images.

FIG. 7 is a schematic view showing a state where human objects are being picked up by respective left and right image pickup optical systems.

FIG. 8A is a schematic view of left and right video images each containing two object images.

FIGS. 8B and 8C are diagrams showing respective correlation values.

FIG. 9 is a schematic view of the left and right video images combined with respective face frames.

FIG. 10 is a schematic view of a face frame obtained when an object moves to a position indicated by an arrow while being picked up by the left and right image pickup optical systems.

FIG. 11 is a schematic view showing a state where object images and face frames are moved in accordance with movement of an object.

FIG. 12 is a timing diagram showing a process from detection of a face area to display of the same.

FIG. 13 is a flowchart of a face frame drawing process executed by an MPU appearing in FIG. 1.

FIG. 14 is a view showing an exemplary case where parallaxes have been corrected such that face frames in a three-dimensional view appear to be at positions further forward of objects, respectively, than original positions each indicated by a dotted line.

FIGS. 15A, 15B, and 15C are views showing examples of face area images, in which FIG. 15A shows an exemplary case where arrow GUI components are used; FIG. 15B shows an exemplary case where GUI components each having a partially-open rectangular shape are used; and FIG. 15C shows an exemplary case where symbols A and B are used for identification of persons indicated by respective face frames.

FIG. 16 is a schematic block diagram of a three-dimensional image pickup apparatus as an image processing apparatus according to a second embodiment of the present invention.

FIG. 17 is a schematic block diagram of an anti-shake processing section appearing in FIG. 16.

FIG. 18A is a schematic view of face areas of respective object images detected by the right-eye-viewing face detection section and a left-eye-viewing face detection section, respectively.

FIGS. 18B and 18C are diagrams showing respective correlation values.

FIG. 19 is a schematic view of left and right video images and face frames to be output to the display panel.

FIG. 20 is a schematic view showing a state where object images and face frames are moved in accordance with movement of an object.

FIG. 21A is a diagram showing relationship between the amount of movement of the face frame and the amount of movement required for animation rendering.

FIG. 21B is a diagram showing graph lines generated for interpolation of the amount of movement.

FIG. 22 is a view useful in explaining variation in the position of each face frame relative to the other.

### DESCRIPTION OF THE EMBODIMENTS

The present invention will now be described in detail below with reference to the accompanying drawings showing embodiments thereof.

Note that in the present embodiment, an image processing apparatus of the present invention is applied to a three-dimensional image pickup apparatus.

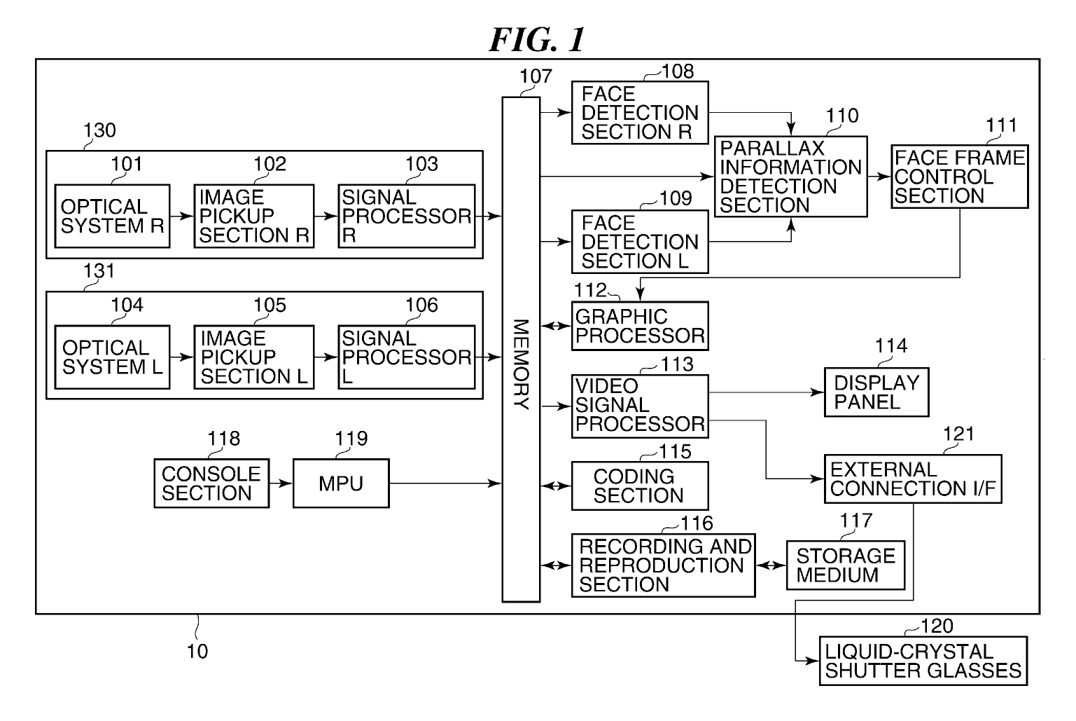

FIG. 1 is a schematic block diagram of the three-dimensional image pickup apparatus, denoted by reference numeral 10, as an image processing apparatus according to a first embodiment of the present invention.

Referring to FIG. 1, each of a right-eye-viewing optical system (optical system R) 101 and a left-eye-viewing optical system (optical system L) 104 comprises lenses including a zoom lens. Each of a right-eye-viewing image pickup section (image pickup section R) 102 and a left-eye-viewing image pickup section (image pickup section L)105 comprises an image pickup device, such as a CMOS sensor or a CCD sensor, for picking up an image from light having passed through an associated one of the right-eye-viewing optical system 101 and the left-eye-viewing optical system 104, and an analog-to-digital converter. Each of a right-eye-viewing signal processor (signal processor R) 103 and a left-eye-viewing signal processor (signal processor L) 106 performs processing including conversion on signals output from an associated one of the right-eye-viewing image pickup section 102 and the left-eye-viewing image pickup section 105. A memory 107 stores video data, encoded data, control data, and so forth. In the following description, the right-eye-viewing optical system 101, the right-eye-viewing image pickup section 102, and the right-eye-viewing signal processor 103 will also be collectively referred to as a right-eye-viewing image pickup optical system (image pickup optical system R) 130. Similarly, the left-eye-viewing optical system 104, the left-eye-viewing image pickup section 105, and the left-eye-viewing signal processor 106 will also be collectively referred to as a left-eye-viewing image pickup optical system (image pickup optical system L) 131. These image pickup optical systems 130 and 131 correspond to an acquisition unit configured to acquire two video images produced by shooting an object.

A right-eye-viewing face detection section (face detection section R) 108 and a left-eye-viewing face detection section (face detection section L) 109 correspond to a detection unit configured to detect a face area in each of the two video images produced by the respective image pickup optical systems 130 and 131.

A parallax information detection section 110 detects parallax information based on face area information acquired from each of the right-eye-viewing face detection section 108 and the left-eye-viewing face detection section 109, and thereby associate the face areas detected from the respective two video images. The parallax information detection section 110 corresponds to a face area-setting unit configured to associate the face area detected in one of the two video images by one of the right-eye-viewing face detection section 108 and the left-eye-viewing face detection section 109 and the face area detected in the other video image by the other of the face detection sections R108 and L109, and cause the position and size of each of the associated face areas for display on a display panel 114 to match each other.

A face frame control section 111 controls the display position and size of each face frame and movement of the face frame based on the face area information from an associated one of the right-eye-viewing face detection section 108 and the left-eye-viewing face detection section 109 and the parallax information detected by the parallax information detection section 110. The face frame control section 111 corresponds to a face area-related information generation unit configured to generate face area-related information including a position on the display panel 114 where a face area image indicative of a face area is to be displayed according to the face area set based on the parallax information detected by the parallax information detection section 110.

A graphic processor 112 generates GUI components, such as icons and character strings, which are to be superimposed on picked-up images. Further, the graphic processor 112 generates a face frame GUI component based on the information from the face frame control section 111, and draws the GUI components in a predetermined area of the memory 107. The graphic processor 112 corresponds to a face area image generation unit configured to generate face area images (e.g. GUI components, such as icons and character strings) according to face area-related information.

A video signal processor 113 combines video data being picked up via the right-eye-viewing optical system 101 and the left-eye-viewing optical system 104 and a GUI component drawn by the graphic processor 112, and then outputs the combined images to the display panel 114. The video signal processor 113 corresponds to an output unit configured to combine the two video images and a face area image, and output respective video signals indicative of the resulting combined images to the display panel 114.

The display panel 114 (display unit) displays the combined video images based on video signals output from the video signal processor 113. The display panel 114 can be implemented e.g. by a liquid crystal panel or an organic EL panel. Display of a three-dimensional video image will be described hereinafter.

A coding section 115 compression-encodes left and right video data stored in the memory 107 for left and right eye views from a pair of respective left and right liquid-crystal shutter glasses 120, referred to hereinafter, and stores the compression-encoded data in the same. Further, in the case of reproduction, the coding section 115 decodes compression-encoded data which is read out from a storage medium 117 and stored in the memory 107, and then stores the decoded data in the same.

A recording and reproduction section 116 writes encoded data stored in the memory 107 into the storage medium 117. Further, the recording and reproduction section 116 reads out data recorded in the storage medium 117.

As the storage medium 117, there may be used e.g. a semiconductor memory, such as a flash memory or an SD card, an optical disk, such as a DVD or a BD, or a hard disk.

A console section 118 detects the status of operation of operating members, such as buttons and switches. Further, when the display panel 114 has a touch panel overlaid thereon, the console section 118 detects a touch operation or movement of a finger or a pen on the touch panel.

An MPU (microprocessor) 119 is capable of controlling various processing blocks via a control bus, not shown. Further, the MPU 119 performs various computation processes and the like to control the overall operation of the apparatus.

An external connection interface 121 is connected to the video signal processor 113 and outputs, in the present embodiment, a predetermined synchronization signal and the like to the liquid-crystal shutter glasses 120 for use in three-dimensional display.

The left and right liquid-crystal shutter glasses 120 are configured such that respective liquid-crystal shutters thereof can be caused to alternately open and close according to the predetermined synchronization signal so as to enable the user to view a three-dimensional video image during shooting or reproduction.

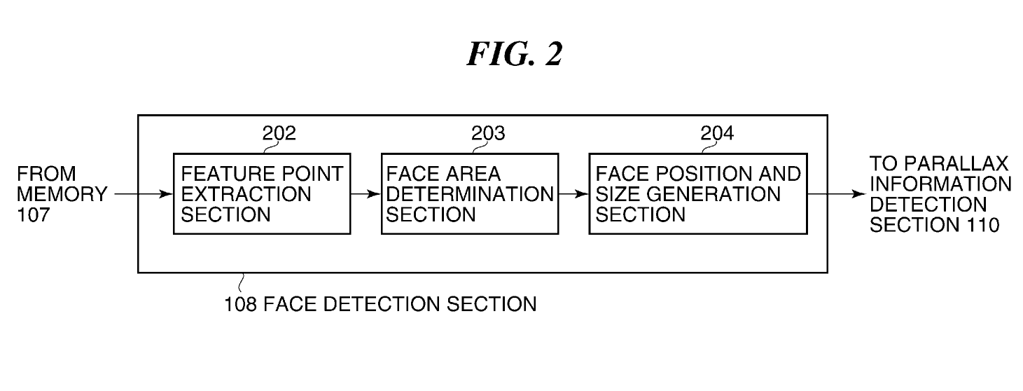

FIG. 2 is a schematic block diagram of the right-eye-viewing face detection section 108 appearing in FIG. 1.

Picked-up video images are temporarily stored in the memory 107. A feature point extraction section 202 of the right-eye-viewing face detection section 108 receives a right picked-up video image for right eye viewing and detects feature points. The feature points include video edge information, color information, and contour information.

Extracted feature data of the feature points is delivered to a face area determination section 203 and is subjected to a predetermined process, whereby a face area is determined. Determination of a face area can be performed using various known techniques. For example, one applicable method is that areas of eyes, a nose, and a mouth as component elements of a face are extracted based on edge information and when the relative position between the areas satisfies a predetermined relationship, a larger area containing the areas of the respective component elements is determined as a face area. Another applicable method is that when the shape and size of an area extracted as a skin-colored area falls within a range matching a human object, the skin-colored area is determined as a face area.

A face position and size generation section 204 generates information on the center position of the face area and the two-dimensional size of the same from the data output from the face area determination section 203. The generated data is output to the parallax information detection section 110.

The left-eye-viewing face detection section 109 performs the same processing as the right-eye-viewing face detection section 108 except that it uses a left picked-up video image for left eye viewing, and therefore description thereof is omitted.

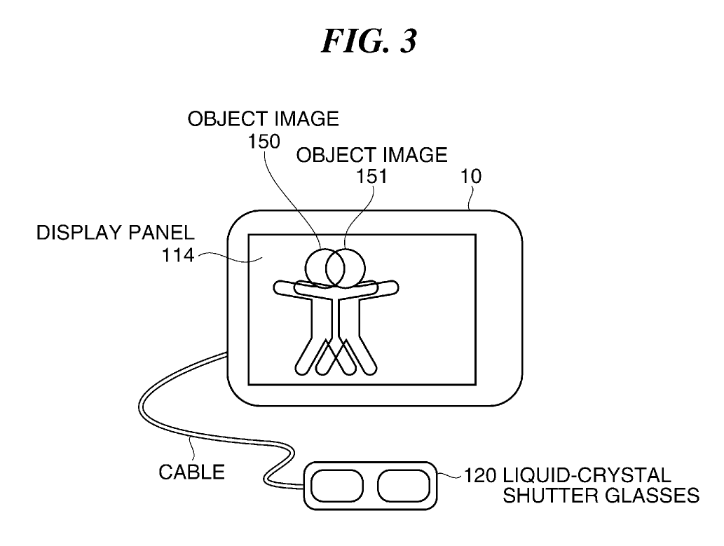

FIG. 3 is a view showing an example of a video image displayed on the display panel 114 of the three-dimensional image pickup apparatus 10 in FIG. 1.

In FIG. 3, the left and right liquid-crystal shutter glasses 120 are connected to the three-dimensional image pickup apparatus 10 by a cable. The display panel 114 is formed by a liquid crystal panel, and displays a video image being shot.

Assuming that the video image being shot for three-dimensional view is viewed without wearing the liquid-crystal shutter glasses 120, object images 150 and 151 obtained by the respective left and right image pickup optical systems are displayed as a double image in which the object images 150 and 151 are displaced from each other.

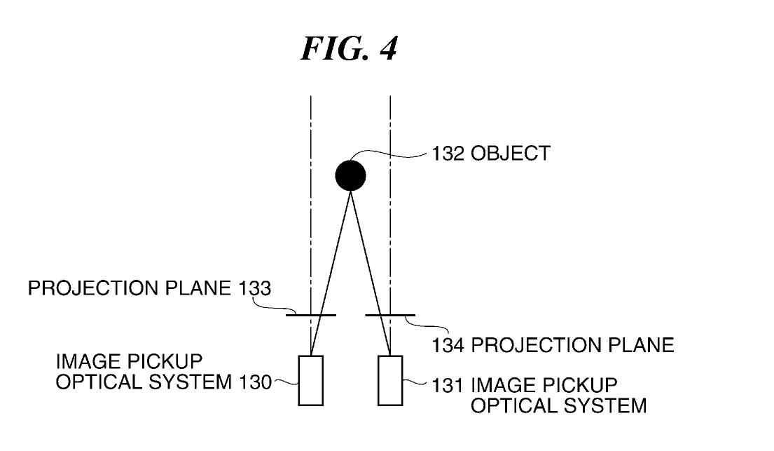

FIG. 4 is a view useful in explaining a displacement between the object images.

In FIG. 4, when an object 132 is shot by the left and right image pickup optical systems 130 and 131, the object images projected onto projection planes 133 and 134 are different in position on the plane of projection, which causes a displacement between the object images.

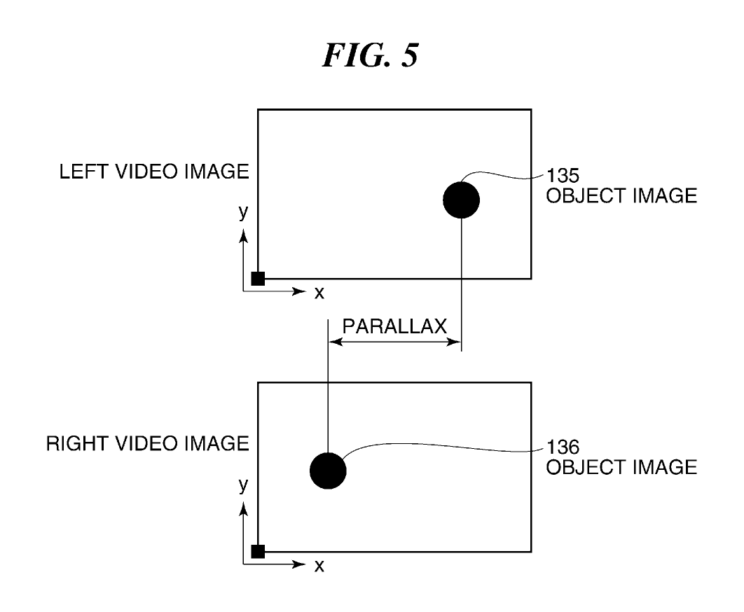

FIG. 5 is a view of the left video image obtained via the projection plane 133 and the right video image obtained via the projection plane 134.

In FIG. 5, the object images 135 and 136 are video images of the object 132. As shown in FIG. 5, the object images 135 and 136 are displayed in respective different positions. When these two video images are alternately displayed on the display panel 114 according to the vertical synchronization signal and observed without using the liquid-crystal shutter glasses, the object 132 is viewed as a double image as illustrated in FIG. 3.

A horizontal displacement in position of the object image between the left and right video images as shown in FIG. 5 is called parallax. The parallax changes with a change in distance from the image pickup optical systems to an object.

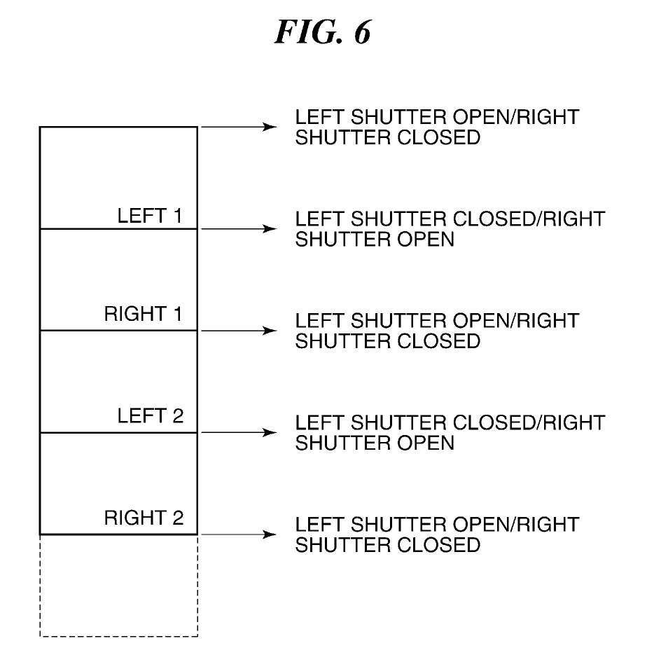

FIG. 6 is a diagram showing timing for switching between left and right video images.

In three-dimensional display, picked-up left and right video images are alternately displayed while switching between the left and right video images e.g. in sequence of LEFT 1, RIGHT 1, LEFT 2, and RIGHT 2 as shown in FIG. 6. This processing is performed by the video signal processor 113 appearing in FIG. 1. The display switching is performed according to the vertical synchronization signal. The synchronization signal is output via the external connection interface 121 in synchronism with switching between the video signals.

The liquid-crystal shutter glasses 120 open and close the left shutter and the right shutter according to the synchronization signal as shown in FIG. 6. Consequently, only the left shutter is opened during display of a video image of LEFT 1, and therefore the image is projected only toward the left eye. On the other hand, only the right shutter is opened during display of a video image of RIGHT 1, and therefore the image is projected only toward the right eye. By carrying out these operations repeatedly and alternately, the video image being picked-up can be viewed by the photographer as a three-dimensional image.

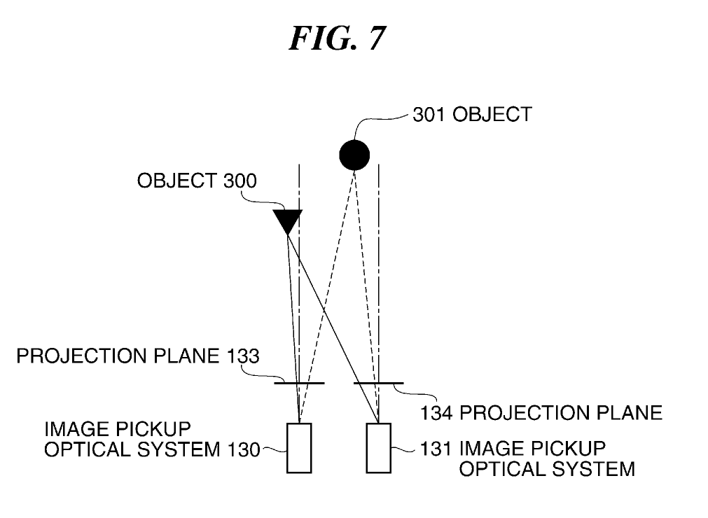

FIG. 7 is a schematic view showing a state where human objects 300 and 301 are being shot by the left and right image pickup optical systems.

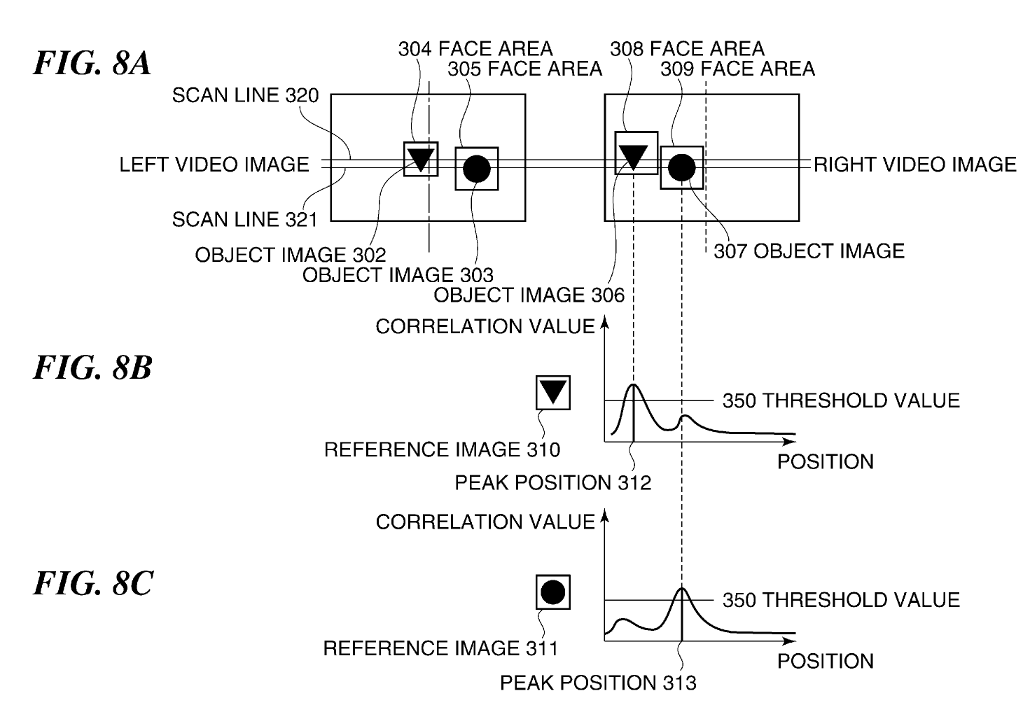

FIG. 8A shows left and right video images each containing two object images, and FIGS. 8B and 8C show respective correlation values.

The left and right images picked up by shooting the objects 300 and 301 as appearing in FIG. 7 are displayed as the respective left and right video images as shown in FIG. 8A. Face areas of respective object images 302 and 303 and 306 and 307 detected by the right-eye-viewing face detection section 108 and the left-eye-viewing face detection section 109 are displayed as respective rectangular face areas 304 and 305 and 308 and 309.

The parallax information detection section 110 associates the face areas in the left video image and the face areas in the right video image and detects parallaxes between the left face areas and the right face areas using face area information acquired from the right-eye-viewing face detection section 108 and the left-eye-viewing face detection section 109 and picked-up image data.

First, reference images are obtained from picked-up video images stored in the memory 107 using information on the face areas 304 and 305 detected in the left video image. A reference image 310 appearing in FIG. 8B is obtained using the face area 304. A reference image 311 appearing in FIG. 8C is obtained using the face area 305.

A search area is set so as to detect a face area corresponding to the reference image 310 from the right video image in FIG. 8A. In the present example, search processing is performed along a scan line 320 passing the vertical center of the rectangular face area 304. Accordingly, the vertical center of the reference image 310 is moved horizontally along the scan line 320 on the right video image to thereby determine values of correlation between the reference image 310 and the right video image at respective predetermined sampling points. The correlation values are calculated using a known technique. For example, the image in the face area 304 is placed on the right video image in an overlapping manner, and a difference between the value of each pixel in the face area 304 and that of a pixel of the right video image corresponding in position to the pixel in the face area 304 is determined. The sum total of differences in pixel value is calculated whenever the face area 304 is moved along the scan line 320. As two images subjected to the pixel difference calculation are more similar to each other, the sum total of differences in pixel value between them is smaller. Therefore, the reciprocal of the sum total of differences can be used as a correlation value.

FIG. 8B shows the correlation value between the reference image 310 and the right video image. In FIG. 8B, as the correlation value is larger, it indicates that the degree of similarity is higher. The degree of similarity is highest when the reference image 310 is at a peak position 312, and therefore, at the peak position 312, the face area 308 in FIG. 8A is associated with the face area 304.

Similarly, FIG. 8C shows the correlation value obtained when search processing is performed along a scan line 321 using the reference image 311 obtained from the face area 305. This correlation value is highest when the reference image 311 is at a peak position 313, and therefore at the peak position 313, the face area 305 is associated with the face area 309.

Note that a threshold value 350 appearing in FIGS. 8B and 8C is set for correlation values at respective peak positions so as to evaluate the reliability of association between two face areas. Two face areas in the respective left and right video images are associated with each other only when the correlation value at a peak position is not smaller than the set threshold value, but are not associated when the peak value is smaller than the threshold value. Face areas which are not associated with each other are not required to have a face frame superimposed thereon, and therefore processing described below is not performed on the face area. This prevents a face frame being superimposed e.g. on the face of an object picked up in only one of left and right video images. As described above, when a maximum correlation value is smaller than the predetermined threshold value, the graphic processor 112 does not generate a face area image.

Although in FIGS. 8B and 8C, processing for obtaining correlation values for one line in the horizontal direction is performed along a predetermined scan line of the right video image, correlation values may be obtained only in the vicinity of the face area 308 or 309 detected in the right video image so as to reduce processing time.

Further, although in the present example, a reference image is generated based on information on a face area in the left video image, the reference image may be generated from the right video image. By executing the above-described processing sequence, it is possible to associate face areas.

A parallax for use in superimposition of a face frame is adjusted based on information on associated face areas. In the present example, a parallax between face frames is set using a position where a peak of the correlation value (maximum correlation value) is obtained.

More specifically, in the left video image, the horizontal and vertical center position of each of the face areas 304 and 305 is set as the center of each face frame. A face frame for the face area 308 in the right video image is set such that the horizontal center of the face frame corresponds to the peak position 312 in FIG. 8B and the vertical center thereof corresponds to the scan line 320. As for the face area 309, a face frame therefor is set such that the horizontal center thereof corresponds to the peak position 313 in FIG. 8C and the vertical center thereof corresponds to the scan line 321.

Thus, the parallax information detection section 110 generates an image indicative of a face area detected in one of two video images, as a reference image, and then, associates the face area detected in the one video image and a face area detected in the other video image, based on an area of the other video image where the value of correlation with the reference image is highest.

The sizes of the respective two face areas are compared with each other, and the size of the face frame is set to a larger size. Therefore, between the face area 304 and the face area 308 in FIG. 8A, the size of the larger face area 308 is set as a face frame size. Further, between the face area 305 and the face area 309, the size of the larger face area 305 is set as a face frame size.

The area of each of the face areas is calculated by multiplication of the width and height of the face area for comparison between the respective sizes of face areas, and the width and height of one of the face areas having a larger area is selected as the size of a face frame.

Although in the present example, a comparison is made between the areas of respective associated face areas, a comparison may be made separately as to each of width and height between the associated face areas, and the width and height of one of the face areas having a largest value of the width and height vales may be selected. As described above, the parallax information detection section 110 makes the size of a face frame equal to the size of one of associated face areas which is larger in area.

The parallax information detection section 110 generates information (face area-related information) on a pair of face areas associated with each other and the position and size of a face frame to be set for each face area, by the above-described processing, and outputs the information to the face frame control section 111.

The face frame control section 111 outputs information on coordinates of a face frame to be drawn, the color of the face frame, and the shape of the same to the graphic processor 112 in predetermined timing. The graphic processor 112 generates a face frame GUI component based on the acquired information, and forms an image of the face frame GUI component as an OSD (on-screen display) frame in a predetermined area of the memory 107.

The video signal processor 113 reads out left and right OSD frames including the face frames formed as described above and left and right video images from the memory 107, combines each of the OSD frames and an associated one of the video images, and outputs the left and right combined video images to the display panel 114.

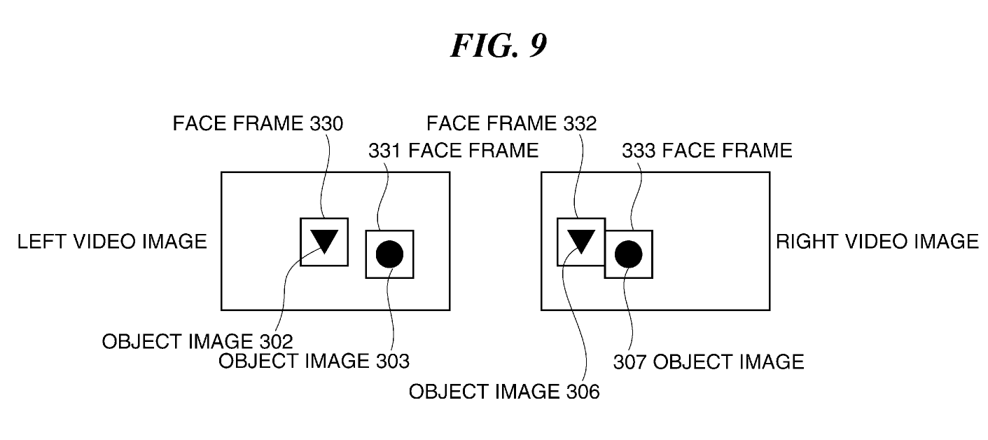

FIG. 9 is a schematic view of the left and right video images combined with the respective face frames.

The face frames 330, 331, 332, and 333 are superimposed on the object images 302, 303, 306 and 307, respectively. A parallax between face frames for the associated ones of the face areas is adjusted by the above-described processing, and the face frames are rendered in the same size.

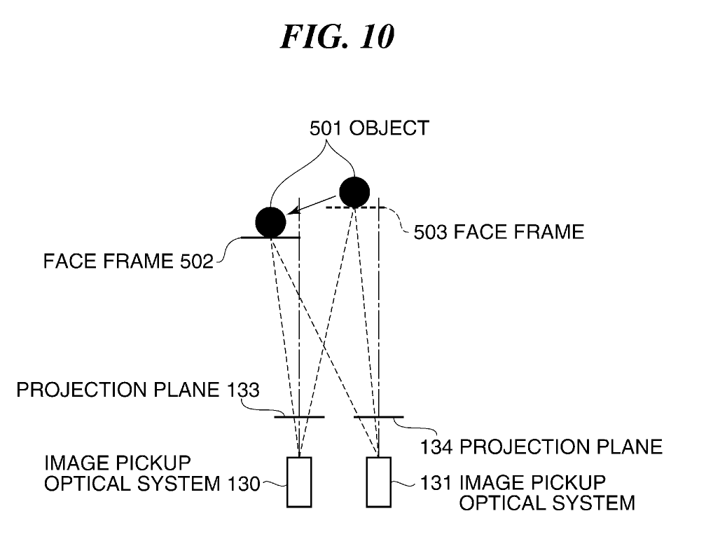

FIG. 10 is a schematic view of a face frame obtained when an object 501 moves to a position indicated by an arrow while the object 501 is being picked up by the left and right image pickup optical systems.

In FIG. 10, the face frames 502 and 503 are virtually disposed in an object space based on the parallax of the face frame. It is possible to adjust the parallax of the face frame in accordance with movement of the object to thereby achieve matching between a three-dimensional effect for the face frame and a three-dimensional effect for the object.

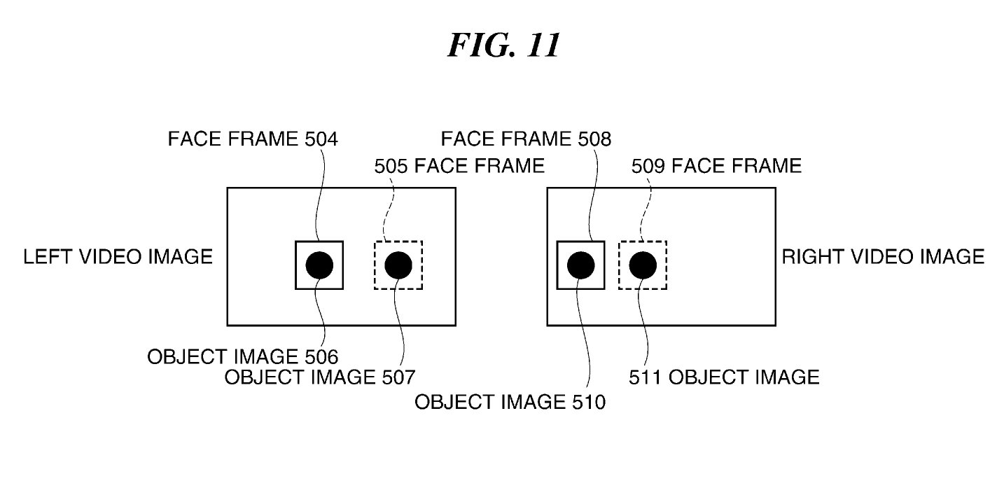

FIG. 11 is a schematic view showing a state where object images and face frames are moved in accordance with movement of an object.

As the object moves, an object image 507 in a left video image is moved to the position of an object image 506, and a face frame 505 is also moved to the position of a face frame 504 in accordance with the movement of the object image. Similarly, in a right video image, an object image 511 is moved to the position of an object image 510, an a face frame 509 is moved to the position of a face frame 508.

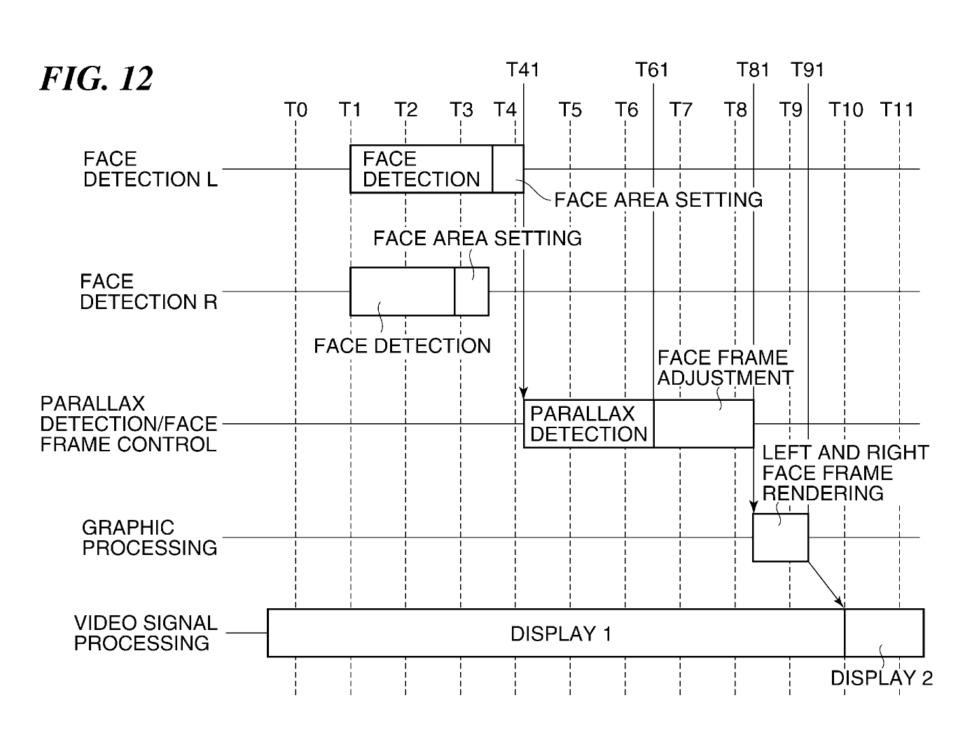

FIG. 12 is a timing diagram showing a process from detection of face areas to display of the same.

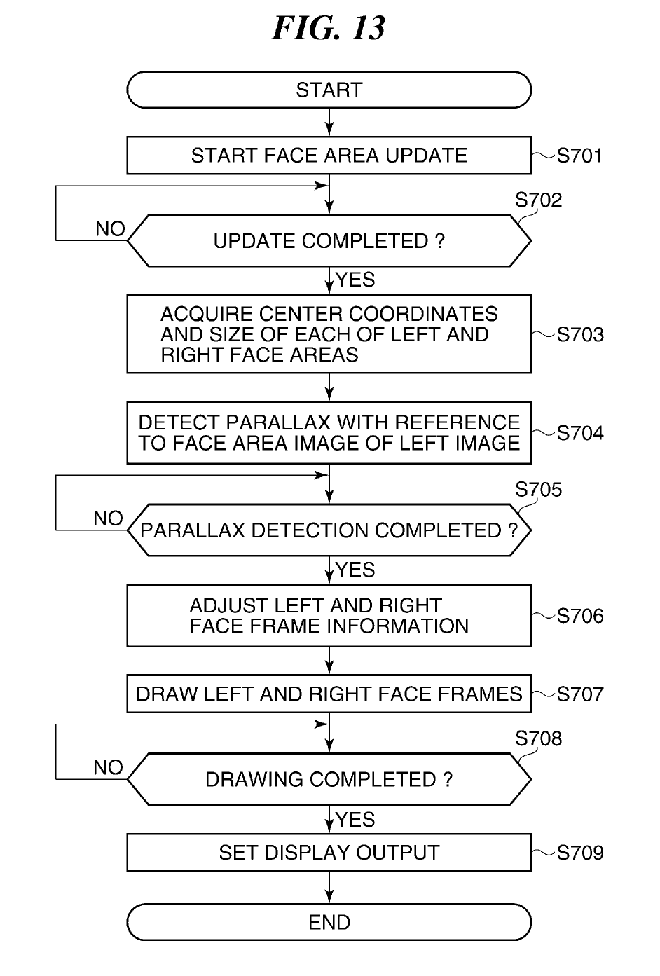

FIG. 13 is a flowchart of a face frame drawing process executed by the MPU 119 appearing in FIG. 1.

A description will be given, with reference to FIGS. 12 and 13, of timing for updating a face frame in accordance with movement of the face frame. First, referring to FIG. 12, time points T1 to T11 indicated by respective dotted lines correspond to the timing of the vertical synchronization signal. Further, “FACE DETECTION L” shows the state of the left-eye-viewing face detection section 109, and “FACE DETECTION R” shows the state of the right-eye-viewing face detection section 108. “PARALLAX DETECTION/FACE FRAME CONTROL” shows the control by the parallax information detection section 110 and the face frame control section 111. “GRAPHIC PROCESSING” shows the control by the graphic processor 112. “VIDEO SIGNAL PROCESSING” shows the control by the video signal processor 113.

Each of the left-eye-viewing face detection section 109 and the right-eye-viewing face detection section 108 can start face detection at any time, but in FIG. 12, it is assumed by way of example that left and right face detections are both started at time T1. Accordingly, in FIG. 13, the operation of each of the left-eye-viewing face detection section 109 and the right-eye-viewing face detection section 108 is operated to start face area update (step S701), and then completion of the update processing is awaited (step S702). However, left and right video images are not the same, and hence time periods taken for face detection in the left and right video images, respectively, are not always the same. Referring again to FIG. 12, the left-eye-viewing face detection section 109 (“FACE DETECTION L”) completes the processing between time T3 and time T4, and then sets face area information. On the other hand, the right-eye-viewing face detection section 108 (“FACE DETECTION R”) completes the processing between time T2 and time T3, and then sets face area information.

In the step S702, it is detected whether or not face areas have been updated, and when results of the left and right face detections are both obtained at time T41 in FIG. 12, it is determined that the face areas have been updated (Yes to the step S702). Then, the parallax information detection section 110 acquires the center coordinates and size of each of the left and right face areas (step S703).

Thereafter, the parallax information detection section 110 generates a reference image with reference to the face area in the left video image (step S704), and starts parallax detection (step S705). When the parallax detection is completed at time T61 in FIG. 12, it is determined that the parallax detection has been completed (Yes to the step S705), and the process proceeds to a step S706.

The face control section 111 adjusts left face frame information and right face frame information based on parallax information (step S706). The face frame information is set in the graphic processor 112 at time T81 in FIG. 12, whereby drawing of the left and right face frames is started (step S707). Then, completion of drawing of the face frames is awaited (step S708).

When the drawing of face frames is completed (YES to the step S708), the video signal processor 113 reads out the data of the drawn face frames at time T91 as shown in FIG. 12, and an output adapted to the display panel 114 is set (step S709). Accordingly, at time T10, the face frames on the display panel 114 are updated and displayed. That is, a screen of DISPLAY 1, which has been displayed so far, is updated to a screen of DISPLAY 2 in which the face frames have been moved. The above-described processing sequence is repeatedly executed, whereby the movement of face frames is performed.

The left and right face frames are moved at the same timing of the same vertical synchronization signal as shown in FIG. 12, which prevents the left and right face frames from being moved separately.

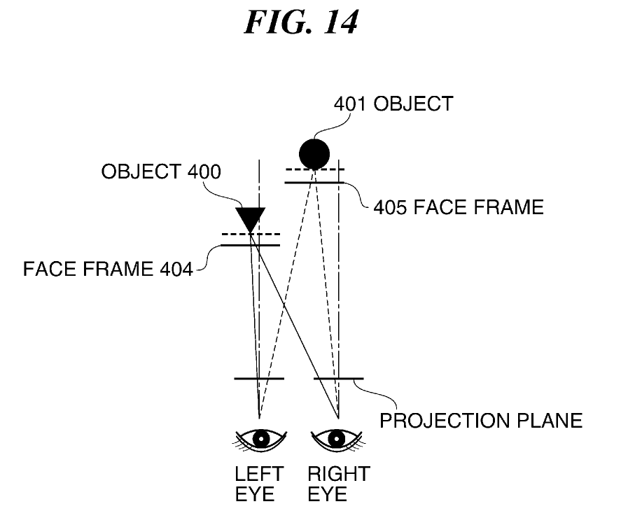

FIG. 14 is a view showing an exemplary case where parallaxes have been corrected such that face frames 404 and 405 in a three-dimensional view appear to be at positions further forward of objects 400 and 401, respectively, than original positions each indicated by a dotted line.

As shown in FIG. 14, offset adjustment of parallax of the face frame may be performed such that the face frames 404 and 405 can be three-dimensionally viewed in front of the respective objects 400 and 401 so as to make the face frames 404 and 405 clearly visible when three-dimensionally viewed. Thus, a face area image may be displayed in front of an image indicative of a face associated with the face area image on the display panel 114.

As a consequence, the face of an object can be three-dimensionally viewed as if the face were in a picture frame. Therefore, even when a detection error or the like occurs, it is possible to prevent the face from appearing as if projecting forward from the face frame to make a photographer feel odd.

Although in the present embodiment, a face area is enclosed by a rectangular frame, it is also possible to use other GUI components to show a face area.

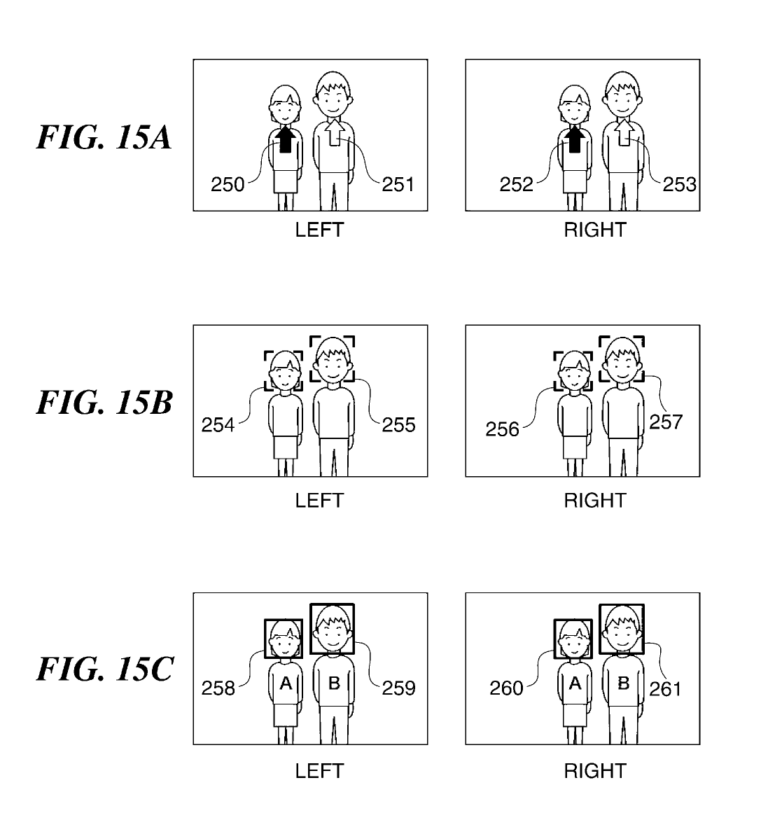

FIGS. 15A, 15B, and 15C are views showing examples of a face area image. FIG. 15A shows an exemplary case where arrow GUI components are used. FIG. 15B shows an exemplary case where GUI components having a partially-open rectangular shape are used. FIG. 15C shows an exemplary case where symbols A and B are used for identification of persons indicated by respective face frames.

Referring to FIG. 15A, arrows different in color are used so as to distinguish human faces associated with each other from other human faces associated with each other. In the case of FIG. 15C, when the apparatus is additionally provided with a person recognition function, it is also possible to display not only a face frame, but also the name or the like of a registered person in place of the symbol A. A face area may be indicated by any other method insofar as the face area can be identified. Thus, the graphic processor 112 may be configured to generate a face area image indicative of face areas associated with each other as the same face area image uniquely corresponding to the associated face area.

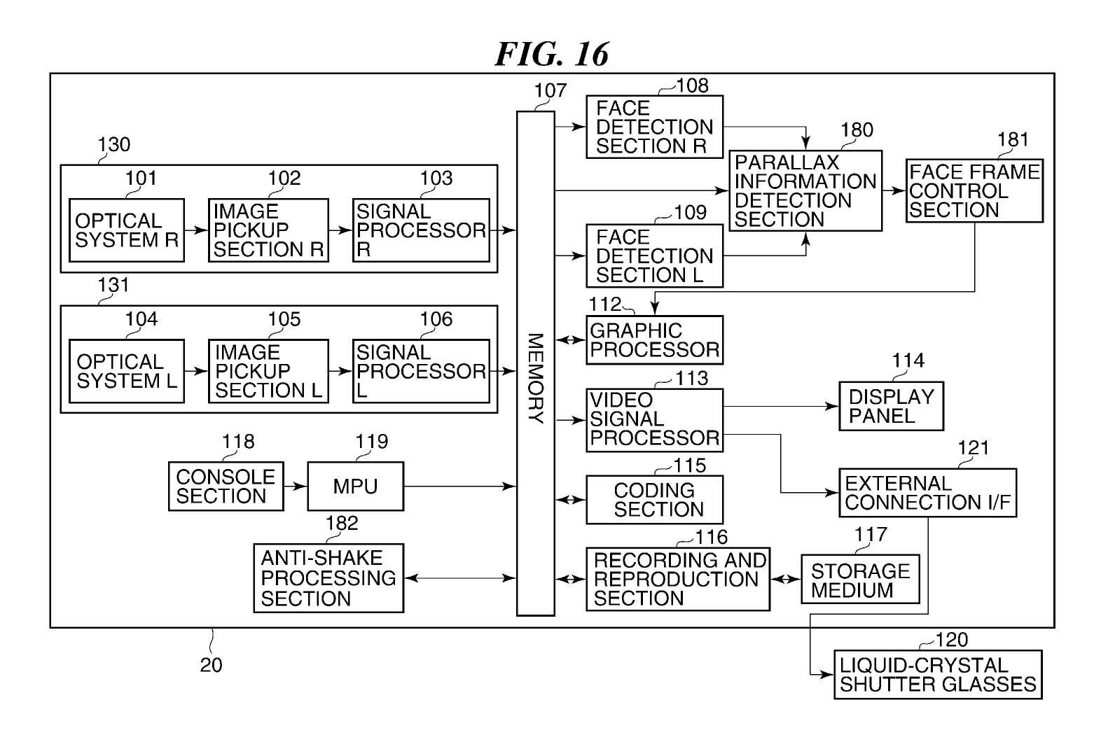

FIG. 16 is a schematic block diagram of a three-dimensional image pickup apparatus 20 as an image processing apparatus according to a second embodiment of the present invention.

The three-dimensional image pickup apparatus 20 is distinguished from the three-dimensional image pickup apparatus 10 according to the first embodiment by a parallax information detection section 180 that associates left and right face areas and detects a parallax of the face frame and a face frame control section 181 that performs face frame control. Further, the three-dimensional image pickup apparatus 20 is provided with an anti-shake processing section 182 for coping with a shake that occurs during three-dimensional shooting.

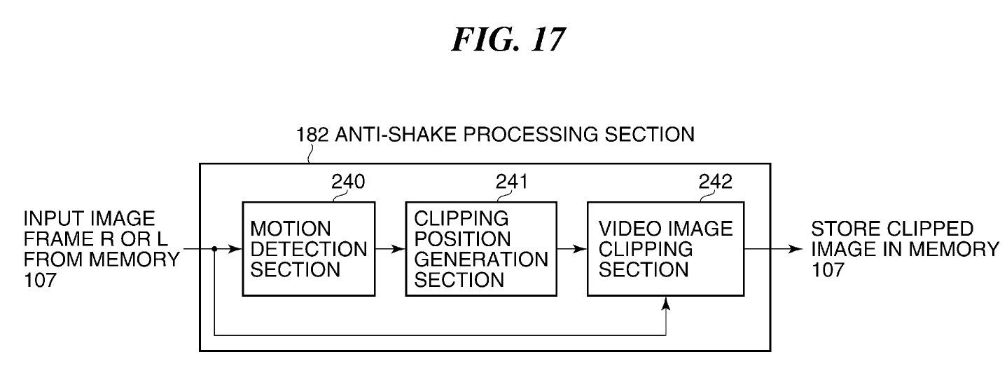

FIG. 17 is a schematic block diagram of the anti-shake processing section 182 appearing in FIG. 16.

In FIG. 17, a motion detection section 240 receives a picked-up video image as a frame image in units of one frame from the memory 107. In the motion detection section 240, a motion vector is detected between consecutive frames, and the amounts of motions in the respective horizontal and vertical directions are calculated. For a method of detecting a motion vector, a known technique is employed.

A clipping position generation section 241 generates information for clipping a predetermined area from an original image frame according to the amount of motion detected by the motion detection section 240. For example, information on the coordinates of a clipping start point and information of width and height are generated. A video image clipping section 242 clips a predetermined area from the image frame in the memory 107 using the clipping position information generated by the clipping position generation section 241 and stores the clipped area in the memory 107.

Although in the present example, a video image stored in the memory 107 is electronically clipped and subjected to anti-shake processing, it is to be understood that it is possible to perform correction for anti-shake e.g. by lens movement in the optical systems. Thus, two video images obtained by shooting an object have blurs due to a shake eliminated therefrom.

In the three-dimensional image pickup apparatus 20 of the present embodiment, anti-shake processing operation can be enabled or disabled e.g. by a button or a switch of the console section 118. When the anti-shake processing operation is enabled, the above-described anti-shake processing is performed on picked-up left and right video images, and then processing for face frame display after face detection is executed.

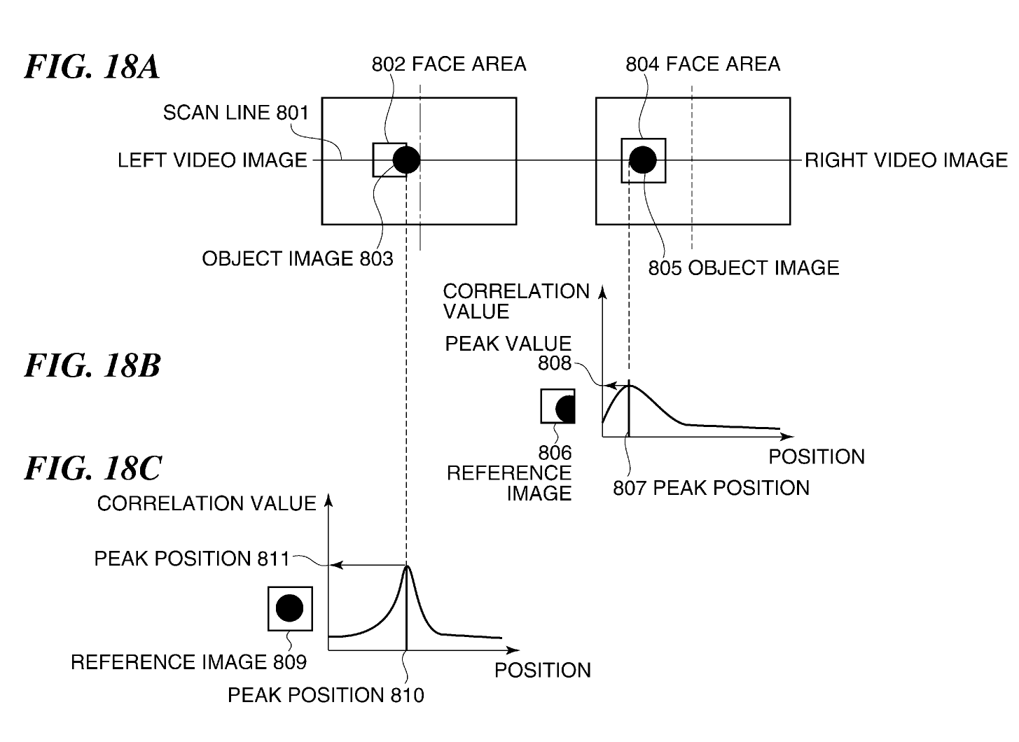

FIG. 18A is a schematic view of face areas of object images 803 and 805, which are detected by the right-eye-viewing face detection section 108 and the left-eye-viewing face detection section 109, respectively. FIGS. 18B and 18C show respective correlation values.

In FIG. 18A, the face area 802 obtained based on the result of face detection in a left video image is in a state displaced from the object image 803.

FIG. 18B shows a result obtained by performing correlation operation along a scan line 801 between a reference image 806 generated from the face area 802 in the left video image and a right video image. As shown in FIG. 18B, a peak value 808 of correlation is obtained at a peak position 807. However, in the reference image 806, the face of the object is partially missing due to an error of face area detection. For this reason, the peak position 807 is slightly deviated leftward from the center of the object image 805 in the right video image. Therefore, when a face frame is set based on the peak position 807, the face frame is drawn at a location deviated from the object image 805. This occurs because association processing and parallax adjustment are performed based on a face area in the left video image.

In the second embodiment, as shown in FIG. 18C, the value of correlation with the left video image is determined using a reference image 809 obtained based on a face area 804 in the left video image. As a consequence, a peak value 811 of the correlation is detected at a peak position 810.

The thus detected two peak values 808 and 811 are compared with each other, and a reference image is selected which gives a higher peak of the correlation value. In the present example, since the peak value 811 is higher in correlation value, a face frame is set with reference to the face area 804 from which the reference image 809 is generated.

As a consequence, in the parallax information detection section 180, the horizontal and vertical center of the face area 804 is set as the center of a face frame for the object image 805. Further, the size of the larger one of the left and right face areas 802 and 804 is set as the size of the face frame. In the left video image, for the object image 803 associated with the object image 805, the horizontal coordinate of the center of the face frame is set to the horizontal coordinate of the peak position 810, and the vertical center of the same is set to the vertical coordinate of the scan line 801.

As described above, the parallax information detection section 180 sets an image indicative of a face area, which is detected in one of two video images, as a first reference image (reference image 809 in the present example), and searches the other video image for an area where the value of correlation with the first reference image is highest. Further, the parallax information detection section 180 sets an image indicative of a face area, which is detected in the other video image, as a second reference image (reference image 806 in the present example), and searches the one video image for an area where the value of correlation with the second reference image is highest. Thereafter, by using an area where a highest correlation value was obtained as results of the search of the first reference image and the second reference image, the parallax information detection section 180 associates the face area detected in the one video image and the face area detected in the other video image.

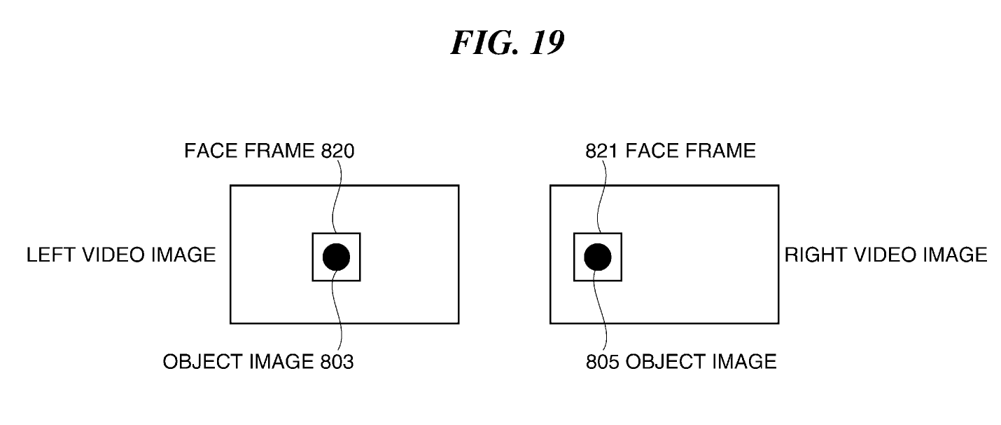

FIG. 19 is a schematic view of left and right video images and face frames output to the display panel 114.

FIG. 19 shows that through the process described with reference to FIGS. 18A to 18C, the face frames 820 and 821 having an appropriate size are superimposed on the respective left and right object images 803 and 805 at respective appropriate positions.

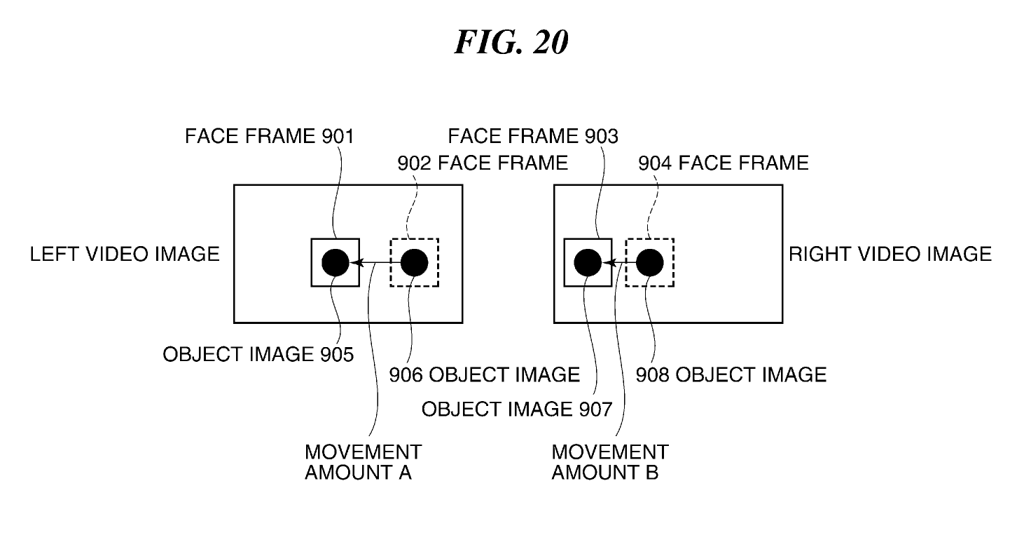

FIG. 20 schematically shows a state in which when an object moves, an object image 906 in a left video image is moved to the position of an object image 905, and accordingly, a face frame 902 is moved to a position of a face frame 901, and an object image 908 in a right video image is moved to a position of an object image 907, and accordingly a face frame 904 is moved to a position of a face frame 903.

The operation of the face frame control section 111 will be described with reference to FIG. 20.

In FIG. 20, the amount of movement of the face frame in the left video image is represented as a movement amount A and the amount of movement of the face frame in the right video image is represented as a movement amount B.

As shown in FIG. 20, the movement amount of each of the left and right face frames changes according to the position of an object and the distance to the object. When the movement amount is large, the face frame is drawn in a flickering manner, which makes the face frame hard to view when three-dimensionally displayed. To solve this problem, in the present embodiment, in the case of moving the left and right face frames, animation rendering is performed at predetermined time intervals according to the movement amounts of the respective left and right face frames so as to achieve smooth face frame movement. To perform animation rendering in moving a face frame is intended to mean that e.g. when a center position of the face frame is changed from a first position to a second position, a position of display of the face frame is changed from the first position to the second position not by a single shift but by a stepwise shift.

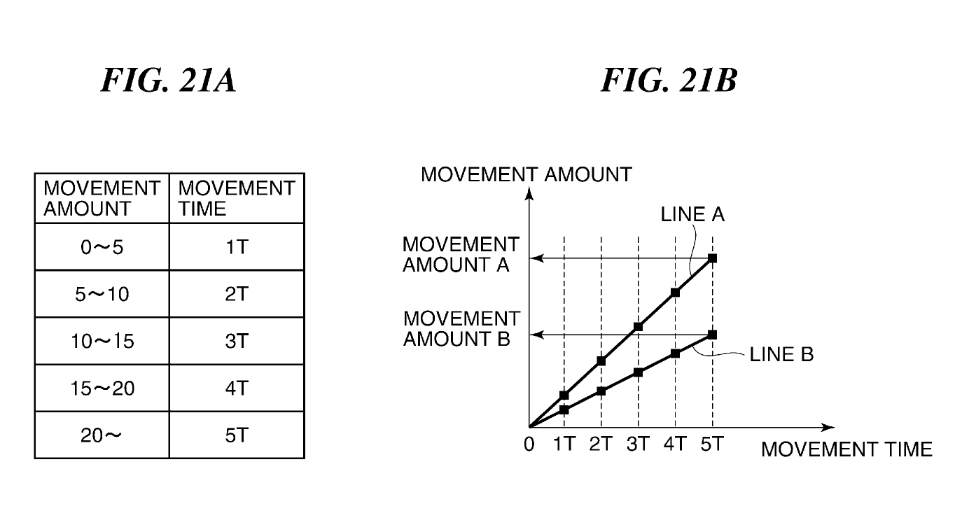

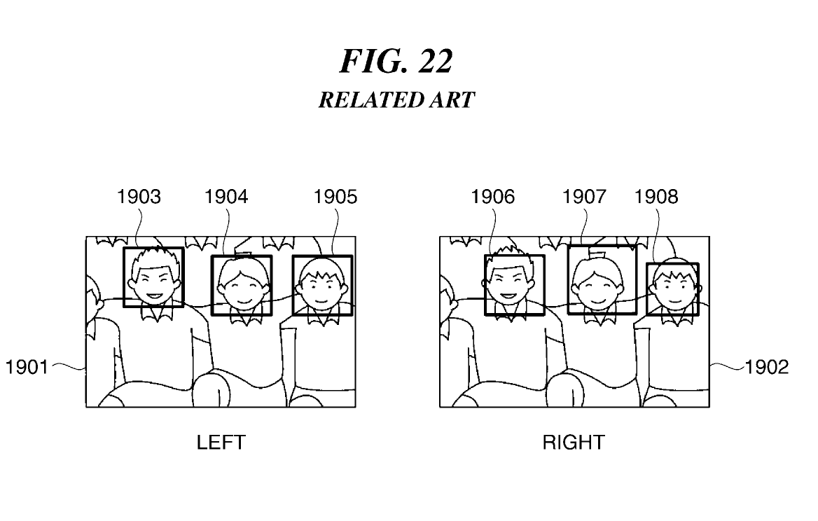

FIG. 21A is a diagram showing relationship between the amount of movement of the face frame and the amount of movement required for animation rendering, and FIG. 21B, and FIG. 21B is a diagram showing graph lines generated for interpolation of the amount of movement.

The face frame control section 111 calculates each of the movement amounts A and B, which are explained with reference to FIG. 20, based on current face frame coordinates and face frame coordinates to be updated next time. Then, the face frame control section 111 compares between the movement amount A and the movement amount B, and sets a movement time period by referring to the FIG. 21A table, based on the bigger one of the movement amounts A and B.

For example, when the movement amount A is equal to 20 and the movement amount B to 10, a movement time period 5T is selected from the FIG. 21A table based on the movement amount A. In FIG. 21A, symbol T represents an update interval which corresponds e.g. to an interval of the vertical synchronization signal delivered to the display panel.

As a consequence, the face frame control section 111 performs control such that each of the left and right face frames is subjected to movement at time intervals of 5T. In the present example, the control is performed such that the face frame control section 111 interpolates and sets a movement amount of each of the left and right face frames corresponding to each update interval T as shown in FIG. 21B.

As for the face frame 904, a line B that reaches the movement amount B in a time period corresponding to update intervals of 5T is generated, and a movement amount corresponding to each update interval T is interpolated using the line B. On the other hand, as for the face frame 902, a line A that reaches the movement amount A in a time period corresponding to update intervals of 5T is generated, and a movement amount corresponding to each update interval T is interpolated using the line A.

The face frame control section 111 outputs information on the coordinates of the center of each of the left and right face frames 904 and 902 to the graphic processor 112 while updating the center coordinates, using a movement amount corresponding to each update interval T and set for an associated one of the face frames 904 and 902.

The graphic processor 112 draws face frames in OSD frames in the memory 107 based on the center coordinates and sizes of the respective left and right face frames.

Although in the present example, the vertical synchronization signal is used for setting an update interval, a counter or the like that operates at predetermined time intervals may be used. For example, it is possible to use e.g. an oscillator or a software timer that operates at predetermined time intervals to set the update interval. Further, the update interval may be variable insofar as it is within a range of accuracy that enables smooth perception of face frame movement in animation.

Through the above-described process, the left and right face frames associated with each other perform smooth transition in synchronism with each other, and therefore it is possible to provide a display screen which is clearly visible when three-dimensionally viewed.

As described above, the face frame control section 181 is capable of updating the position of each face area in predetermined timing (i.e. in accordance with the vertical synchronization signal) and calculating an amount of movement of each detected face area. The face frame control section 181 interpolates a position for display of a face area image between a position before movement and a position after the movement according to the calculated amount of movement and updates the position of the face area to the interpolated position in the predetermined timing.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2011-106212 filed May 11, 2011, which is hereby incorporated by reference herein in its entirety.

What is claimed is:

1. An image processing apparatus including a display unit, comprising:
an acquisition unit configured to acquire two video images obtained by shooting an object;
a detection unit configured to detect a face area in each of the two video images acquired by said acquisition unit;
a face area-setting unit configured to associate the face area detected in one of the two video images by said detection unit and the face area detected in the other video image by said detection unit, and set positions and sizes of the face areas associated with each other, for display on the display unit, such that the positions and sizes of the face areas match each other;
a face area-related information generation unit configured to generate face area-related information including positions on the display unit where face area images indicative of the face areas set by said face area-setting unit are to be displayed;
a face area image generation unit configured to generate the face area images according to the face area-related information generated by said face area-related information generation unit; and
an output unit configured to combine the two video images with the face area images generated by said face area image generation unit, respectively, and output combined video images to the display unit.

2. The image processing apparatus according to claim 1, wherein said face area image generation unit generates face area images each indicative of associated face areas, as an identical face area image for each associated face areas.

3. The image processing apparatus according to claim 1, wherein said face area-related information generation unit updates the positions of the respective face areas in predetermined timing and is capable of calculating an amount of movement of each of the face areas detected by said detection unit, and said face area-related information generation unit interpolates a position for display of a face area image between a position before movement and a position after the movement according to the calculated amount of movement and updates the position of the face area to the interpolated position in the predetermined timing.

4. The image processing apparatus according to claim 1, wherein said face area-setting unit sets an image indicative of the face area detected in the one video image by said detection unit, as a reference image, and by using an area in the other video image, where a value of correlation with the reference image is highest, associates the face area detected in the one video image and the face area detected in the other video image.

5. The image processing apparatus according to claim 1, wherein said face area-setting unit sets an image indicative of the face area detected in the one video image by said detection unit, as a first reference image, to search the other video image for an area where a value of correlation with the first reference image is highest, and sets an image indicative of the face area detected in the other video image by said detection unit, as a second reference image, to search the one video image for an area where a value of correlation with the second reference image is highest, whereafter by using an area where a highest correlation value is obtained as results of the search of the other video image using the first reference image and the one video image using the second reference image, said face area-setting unit associate the face area detected in the one video image and the face area detected in the other video image.

6. The image processing apparatus according to claim 4, wherein when the highest correlation value is smaller than a predetermined threshold value, said face area image generation unit does not generate the face area image.

7. The image processing apparatus according to claim 1, wherein said face area-setting unit causes the size to match a size of one of the associated face areas lager in area.

8. The image processing apparatus according to claim 1, wherein the face area image is displayed in front of an image of a face corresponding to the face area image, on the display unit.

9. The image processing apparatus according to claim 1, wherein the two video images obtained by shooting the object have blurs due to a shake eliminated therefrom.

10. A method of controlling an image processing apparatus including a display unit, comprising:
acquiring two video images obtained by shooting an object;
detecting a face area in each of the acquired two video images;
associating the face area detected in one of the two video images and the face area detected in the other video image, and setting positions and sizes of the face areas associated with each other, for display on the display unit, such that the positions and sizes of the face areas match each other;
generating face area-related information including positions on the display unit where face area images indicative of the set face areas are to be displayed;
generating the face area images according to the generated face area-related information; and
combining the two video images with the generated face area images, respectively, and outputting combined video images to the display unit.

11. A non-transitory computer-readable storage medium storing a computer-executable program for executing a method of controlling an image processing apparatus including a display unit,
wherein the method comprises:
acquiring two video images obtained by shooting an object;
detecting a face area in each of the acquired two video images;
associating the face area detected in one of the two video images and the face area detected in the other video image, and setting positions and sizes of the face areas associated with each other, for display on the display unit, such that the positions and sizes of the face areas match each other;
generating face area-related information including positions on the display unit where face area images indicative of the set face areas are to be displayed;
generating the face area images according to the generated face area-related information; and
combining the two video images with the generated face area images, respectively, and outputting combined video images to the display unit.
